(19) United States
(12) Patent Application Publication
(10) Pub. No.: US 2012/0096546 A1
(43) Pub. Date: Apr. 19, 2012

(54) Edge server HTTP POST message processing

(75) Inventors: John A. Dilley, Los Altos, CA (US); Stephen L. Ludin, Mill Valley, CA (US); John F. Summers, Waban, MA (US)

(73) Assignee: AKAMAI TECHNOLOGIES, INC., Cambridge, MA (US)

(21) Appl. No.: 13/111,676

(22) Filed: May 19, 2011

Related U.S. Application Data
(60) Provisional application No. 61/346,243, filed on May 19, 2010.

(51) Int. Cl. G06F 17/00; G06F 21/00

(52) U.S. Cl. 726/22; 715/236

(57) ABSTRACT

A CDN edge server process receives an HTTP message, takes a given action with respect to that message, and then forwards a modified version of the message to a target server, typically a server associated with a CDN customer. The process may include an associated intermediate processing agent (IPA) or a sub-processing thread to facilitate the given action. In one embodiment, the message is an HTTP POST, and the given action comprises the following: (i) recognizing the POST, (ii) removing given data from the POST, (iii) issuing an intermediate (or subordinate) request to another process (e.g., a third party server), passing the given data removed from the POST to the process, (iv) receiving a response to the intermediate request, (v) incorporating data received from or associated with the response into a new HTTP message, and (vi) forwarding the new HTTP message onto the target server. In this manner, the given data in the POST may be protected as the HTTP message “passes through” the edge server on its way from the client to the target (merchant) server. In an alternative embodiment, data extracted from the POST message is enhanced by passing the data to an externalized process and adding a derived value (such as a fraud risk score based on the data) back into the message.

This application is based on Ser. No. 61/346,243, filed May 19, 2010.

This application includes subject matter protected by copyright, and all rights are reserved.

1. Technical Field

This disclosure relates generally to transaction processing at a server in a distributed network.

2. Brief Description of the Related Art

Distributed computer systems are well-known in the prior art. One such distributed computer system is a “content delivery network” or “CDN” that is operated and managed by a service provider. The service provider typically provides the content delivery service on behalf of third parties. A “distributed system” of this type typically refers to a collection of autonomous computers linked by a network or networks, together with the software, systems, protocols and techniques designed to facilitate various services, such as content delivery or the support of outsourced site infrastructure. Typically, “content delivery” means the storage, caching, or transmission of content, streaming media and applications on behalf of content providers, including ancillary technologies used therewith including, without limitation, DNS query handling, provisioning, data monitoring and reporting, content targeting, personalization, and business intelligence.

It is desired to provide CDN customers with one or more “edge” services that can take advantage of the scalability, availability and reliability of a distributed network of this type.

### BRIEF SUMMARY

Several enhanced “edge services” are provided by an edge server message processing method and apparatus, as described herein.

According to this disclosure, a CDN edge server process receives an HTTP message, takes a given action with respect to that message, and then forwards a modified version of the message to a target server, typically a server associated with a CDN customer. The edge server process may include an associated intermediate processing agent (IPA) or a sub-processing thread to facilitate the given action. The edge server process receives configuration data, referred to as metadata, to control the processing.

In an illustrative embodiment, the message is an HTTP POST, and the given action comprises the following: (i) recognizing the POST, (ii) removing given data from the POST, (iii) issuing an intermediate (or subordinate) request to another process (e.g., a third party server), passing the given data removed from the POST to the process, (iv) receiving a response to the intermediate request, (v) incorporating data received from or associated with the response into a new HTTP message, and (vi) forwarding the new HTTP message onto the target server. In this manner, the given data in the POST may be protected as the HTTP message “passes through” the edge server on its way from the client to a target server, such as a merchant.

This technique has the effect of protecting or enhancing data within an HTTP POST message body as that POST traverses the edge server. In one embodiment, the edge server process uses this “out of band” processing to receive (from the third party “process”) a handle or “nonce” that it then positions in the HTTP POST message body in lieu of the data that is desired to be protected (from being passed on to the merchant web application). This substitution has the effect of obfuscating the data within the POST message body that is desired to be “protected.” In another embodiment, the data within the HTTP POST message body is not necessarily removed but rather is “enhanced,” for example, by examining the existing data and adding a derivative value, such as a fraud risk score based on the data, the result of a lookup of a value in the POST body against a database of part numbers to facilitate cross-vendor ordering, or the like.

The described technique may operate with other HTTP message types.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

FIG. 1 depicts an exemplary block diagram of a distributed computer system environment in which exemplary aspects of the illustrative embodiments may be implemented;

FIG. 2 is an exemplary block diagram of an edge server machine in which the disclosed subject matter may be implemented;

FIG. 3 is a block diagram that illustrates processing of an HTTP request according to the techniques of this disclosure; and

FIG. 4 illustrates how the edge server processing in FIG. 3 is used to facilitate an edge tokenization operation.

### DETAILED DESCRIPTION

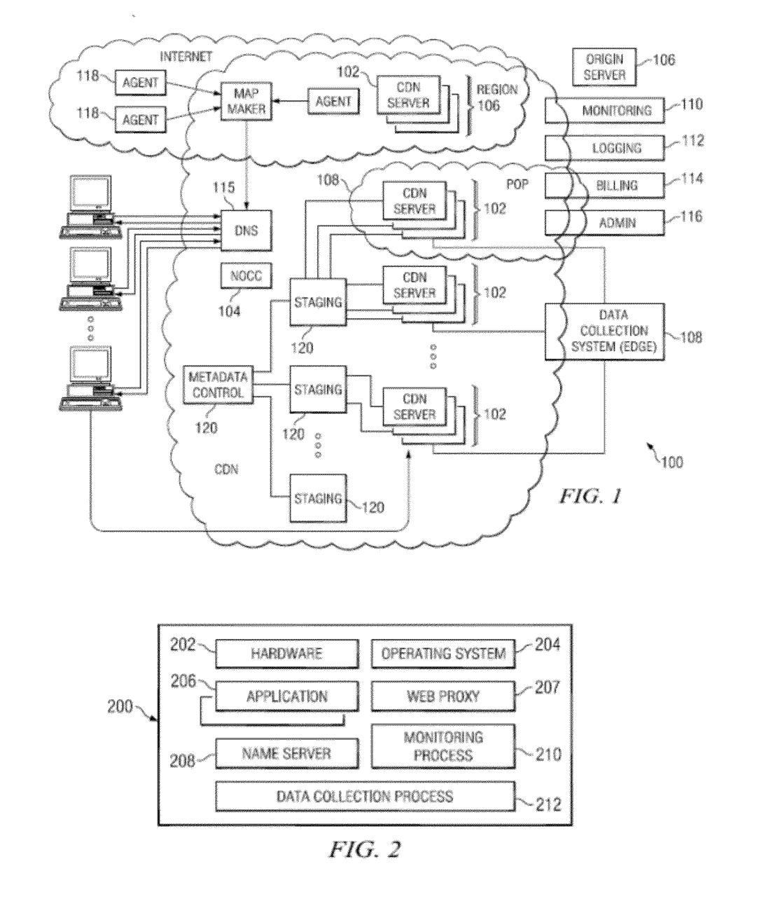

In a known system, such as shown in FIG. 1, a distributed computer system 100 is configured as a CDN and is assumed to have a set of machines 102a-n distributed around the Internet. Typically, most of the machines are servers located near the edge of the Internet, i.e., at or adjacent end user access networks. A network operations command center (NOCC) 104 manages operations of the various machines in the system. Third party sites, such as web site 106, offload delivery of content (e.g., HTML, embedded page objects, streaming media, software downloads, and the like) to the distributed computer system 100 and, in particular, to “edge” servers. Typically, content providers offload their content delivery by aliasing (e.g., by a DNS CNAME) given content provider domains or sub-domains to domains that are managed by the service provider's authoritative domain name service. End users that desire the content are directed to the distributed computer system to obtain that content more reliably and efficiently. Although not shown in detail, the distributed computer system may also include other infrastructure, such as a distributed data collection system 108 that collects usage and other data from the edge servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115, which is authoritative for content domains being managed by the CDN. A distributed data transport mechanism 120 may be used to distribute control information (e.g., metadata to manage content, to facilitate load balancing, and the like) to the edge servers.

As illustrated in FIG. 2, a given machine 200 comprises commodity hardware (e.g., an Intel Pentium processor) 202 running an operating system kernel (such as Linux or variant) 204 that supports one or more applications 206a-n. To facilitate content delivery services, for example, given machines typically run a set of applications, such as an HTTP proxy 207 (sometimes referred to as a “global host” process), a name server 208, a local monitoring process 210, a distributed data collection process 212, and the like. For streaming media, the machine typically includes one or more media servers, such as a Windows Media Server (WMS) or Flash server, as required by the supported media formats.

A CDN edge server is configured to provide one or more extended content delivery features, preferably on a domain-specific, customer-specific basis, preferably using configuration files that are distributed to the edge servers using a configuration system. A given configuration file preferably is XML-based and includes a set of content handling rules and directives that facilitate one or more advanced content handling features. The configuration file may be delivered to the CDN edge server via the data transport mechanism. U.S. Pat. No. 7,111,057 illustrates a useful infrastructure for delivering and managing edge server content control information, and this and other edge server control information can be provisioned by the CDN service provider itself, or (via an extranet or the like) the content provider customer who operates the origin server.

The CDN may include a storage subsystem, such as described in U.S. Pat. No. 7,472,178, the disclosure of which is incorporated herein by reference. The CDN may operate a server cache hierarchy to provide intermediate caching of customer content; one such cache hierarchy subsystem is described in U.S. Pat. No. 7,376,716, the disclosure of which is incorporated herein by reference. The CDN may provide secure content delivery among a client browser, edge server and customer origin server in the manner described in U.S. Publication No. 20040093419. Secure content delivery as described therein enforces SSL-based links between the client and the edge server process, on the one hand, and between the edge server process and an origin server process, on the other hand. This enables an SSL-protected web page and/or components thereof to be delivered via the edge server.

### HTTP POST Message Processing

With the above as background, the subject matter of this disclosure is now described.

According to an aspect of this disclosure, a CDN edge server process receives an HTTP message, takes a given action with respect to that message, and then forwards a modified version of the message to a target server, typically a server associated with a CDN customer. The process may include an associated intermediate processing agent (IPA) or a sub-processing thread to facilitate the given action, but this is not strictly required. Preferably, the process receives configuration data, referred to as metadata, to control the processing of the HTTP message.

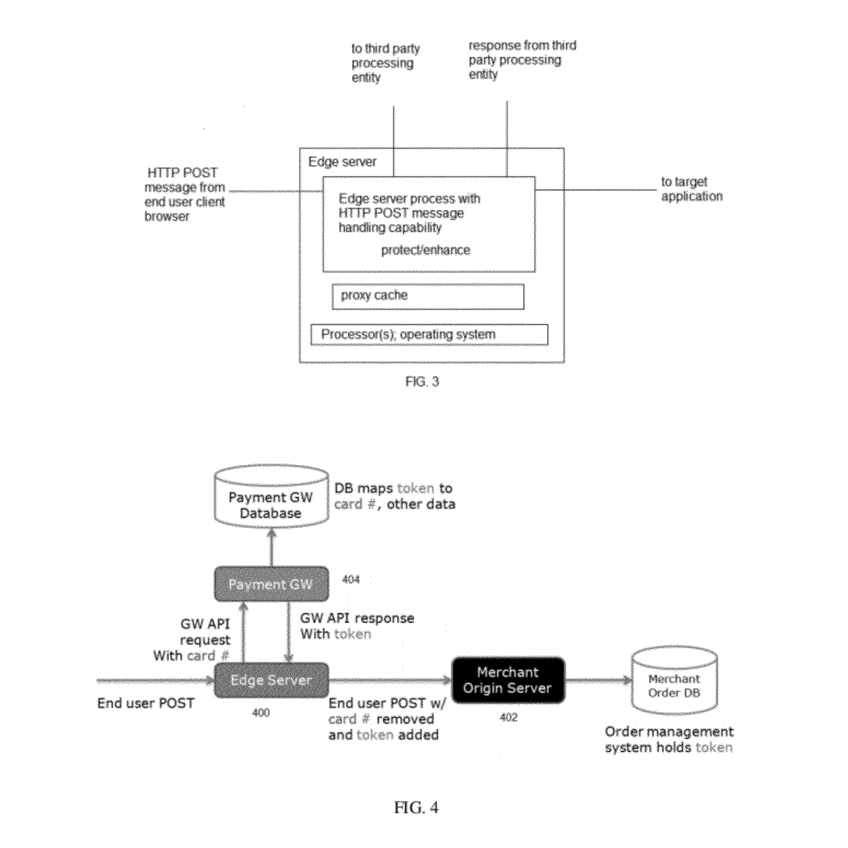

In one embodiment, the message is an HTTP POST, and the given action comprises the following: (i) recognizing the POST, (ii) removing given data from the POST, (iii) issuing an intermediate (or subordinate) request to another process (e.g., a third party server), passing the given data removed from the POST to the process, (iv) receiving a response to the intermediate request, (v) incorporating data received from or associated with the response into a new HTTP message, and (vi) forwarding the new HTTP message onto the target server. In this manner, the given data in the POST may be protected as the HTTP message “passes through” the edge server on its way from the client to the target (merchant) server. FIG. 3 illustrates the processing.

In this embodiment, the technique has the effect of obfuscating or obscuring data within an HTTP POST message body as that POST traverses the edge server. In particular, the edge server process uses this “out of band” processing to receive (from the third party “process”) a handle or “nonce” that it then positions in the HTTP POST message body in lieu of the data that is desired to be protected (from being passed on to the merchant web application).

An application of this approach is an edge-based “tokenization” where the HTTP POST is generated from a SSL-protected web page (e.g., a merchant checkout page from an e-commerce web site that is delivered via the CDN), and the intermediate request passes a credit card (CC) number to a third party payment gateway. In this case, the data received form the intermediate request is a token, which token is then placed in the HTTP request that is passed onto the merchant origin server (and, in particular, a web order management application executing thereon). FIG. 4 illustrates this processing for edge server 400. In this embodiment, the merchant origin server 402 operates an order management system that serves SSL-protected order management pages. The order management application executing on this server is the target application for the HTTP POST message received at the edge server from an end user client browser and, in particular, an SSL-protected web page having one or more fill-in fields that are used to populate the HTTP POST message). In this example, the external process with which the edge server communicates is a payment gateway 404, typically managed by a third party entity. As described, the edge server intercepts the HTTP POST, parses the data, passes the extracted data to the payment gateway 404, which uses its associated gateway database to generate token. The token is returned from the gateway to the edge server, which includes the token back into the HTTP POST and sends the modified POST on to the order management application. The order management application can then communicate with the gateway directly, passing the token, and receiving an authorization. This latter operation takes place external to the edge server and is a known function.

The HTTP POST message processing technique may also be used to “enhance” the data in the message as opposed to just protecting (obscuring) it. In this approach, the data in the POST message is examined. Based at least in part on that examination, the data is “enhanced,” perhaps by including a value that is derived in whole or in part from the data in the POST. As one example, an edge-based “fraud” detection service may be implemented across the edge servers. A representative edge server would then perform the following: HTTP POST scanning, IPA-based forward request, e.g., to a fraud platform “process,” receiving a response (e.g., a risk score), and (risk score) injection into the original POST that is then passed on to the target (merchant) server (application). This is an example of “enhancing” the HTTP POST data and, in particular, by examining the existing data (in the POST) and adding a derivative value.

The fraud score embodiment is just a representative example of the “enhancement” technique. Another example would be a cross-vendor ordering service, in which case the derived value may be based on a lookup of the value in the POST body against an external database of part numbers, or the like. The particular applications for the approach thus are quite varied.

Where the edge server process (or IPA if used) communicates with an external process, the communications may be over SSL, via a Web service, or the like.

Another alternative is an edge-based encryption wherein a given field in the HTTP message is encrypted (or, if already encrypted, decrypted) with a key as the HTTP message passes through the edge server.

Preferably, metadata is used to configure the edge server process to provide one or more of these edge service functions. The above-described processing may take place over communication links using SSL (or its equivalent).

The HTTP message being processed is not necessarily limited to a POST, as the above-described techniques may be implemented on other HTTP message formats, such as GET, PUT, or the like.

An illustrative example of one of these services, edge-based tokenization, is now described. This example should not be taken by way of limitation.

The following provides additional technique details of a representative implementation of the edge tokenization service. As noted above, this service is merely representative.

### Module Summary

In general, the tokenization module (operation) replaces a card number in an eCommerce transaction with an anonymous “token” supplied by a third party payment gateway. This reduces risk of exposure of card numbers for our merchant customers and may help take the merchant's web site out of PCI scope.

In general, tokenization is the capability for a CDN edge server to:
1. Recognize the POST of a customer web page that contains a card number
2. Search the POST data body to retrieve the card number
3. Make a web services call to a payment gateway tokenization API, passing the card number, a merchant identifier as well as other information as needed by the gateway API
4. Receive back a token in reply from the payment gateway API
5. Replace the card number in the POST body with the token
6. Forward the modified POST request to the origin web application
7. Secure the card number in memory; do not write it to disk

As used herein, “card number” means any PCI sensitive data that can be replaced by a token, for example a credit or debit card number, a bank account number, and so forth. The token and the card number it represents are stored securely in a data vault managed by the payment gateway provider.

A third party payment gateway need not always be used. The “token” generation (or, more generally, the processing being carried out by the target of the intermediate or subordinate request) may be performed by the CDN in appropriate circumstances.

### High Level Design

The tokenizer uses a POST request parser, an Intermediate Processing Agent (IPA), and adds ability for IPA to POST (preferably over SSL), client POST body modification, error handling, logging and reporting. FIG. 3 illustrates the typical request flow processing.

Note that the module accesses personally identifiable information (consumer name, card number, home address, and so forth). Preferably, the edge server process does not write any PII to disk (for logging, billing or other purposes).

The module preferably provides customer controls over the authenticators used to access the payment gateway. The bulk of the metadata configuration management in this version of the module is customized via metadata. In an alternative embodiment, template-based configuration management may be provided for customer self-service.

The sections that follow present a high level design for the components and processes that implement edge tokenization.

### 1.1 Customer Integration and Configuration Management

Edge-based tokenization integration and configuration management (provisioning) preferably is done through a customer (secure extranet portal) configuration application. As described below, metadata provides an interface to extract cardholder data from the POST body, generate the intermediate request to the payment gateway, and modify the forward POST transaction. Use of that metadata plus a tokenization tag constitutes activation of this module.

### 1.1.1 Payment Gateway Integration

The tokenization request to the payment gateway depends on the API available from the gateway provider. At a minimum, the solution supports an HTTPS POST request with a text reply of key=value pairs or an XML document reply. The gateway interface may be password protected using HTTP Basic Auth credentials in the HTTP headers or as a key=value in the POST body. If the gateway will allow it, the edge machine may be securely authenticated to the payment gateway. This avoids the merchant having to share their payment gateway credentials with the CDN service provider.

### 1.1.2 Merchant Integration

The fields to extract from the POST body depend on the merchant's shopping card or order processing software. The syntax and semantics are managed through metadata in the merchant's metadata configuration. Example metadata is set forth below.

The payment gateway requires merchant identification and authentication, often a username and password for the merchant. These credentials to the merchant's gateway account are security sensitive and preferably are not stored cleartext in metadata. Instead, the edge server process preferably retrieves the credentials via a key management infrastructure to prevent them being available in the clear.

Merchant authenticators (and any other secrets required) preferably are managed via a portal configuration management interface to prevent customers having to transmit secrets to the CDN employees via email or other mechanisms.

Any payment transaction configured for edge tokenization would be authorized to use the merchant's credentials to access the payment gateway.

### 1.2 Edge Server Behavior

Edge Tokenization leverages an intermediate processing agent (IPA) feature within the edge process to interact with the payment gateway API. The construction of the POST to the payment gateway is flexible enough to allow integration of new payment processors without requiring a code change.

The following provides a high level design of the edge server features.

### 1.2.1 Summary of Pertinent Edge Server Process Functions

Extract values out of URL encoded POST body into variables.
Modify IPA so that it can make arbitrary POST requests over SSL to a payment gateway.
   The POST body may be a URL encoded form body or possibly an XML SOAP body.
Access payment gateway authenticators and other secret information through an appropriate key distribution channel, preventing cross-customer secret sharing through appropriate checks on the secret.
Parse gateway POST response into metadata variables.
Modify the end user's inbound POST body using one or more of the following operations:
   Replace a named parameter's value with a different value.
   Add a named parameter with a given value.
   Remove a named parameter and its value, optionally replacing value with ‘X’ chars
Send the modified POST body to the merchant's origin server and continue processing the POST request and response as usual.
Include sufficient information in log lines for debugging and troubleshooting.
Ensure that card numbers and other sensitive information are kept secure. The card number is not written to any file or query table.

### 1.2.2 Edge Server Request Processing Details

The primary edge server steps in the processing of edge-based tokenization are set forth below.
1. Identify the merchant identifier to use in the tokenizer call. This can be a simple metadata tag or perhaps a metadata variable.
2. Extract card number and cardholder data fields from HTTPS POST requests into metadata variables.
   URL encoded POST bodies from an HTML form. The request will have a Content-Type: application/x-www-form-urlencoded header and the format of the POST body will be similar to a query string.
   The variable holds the value as URL encoded (unmodified)
   The edge server process extracts variable values with these selectors: ARGS ARGS_NAME ARGS_POST ARGS_POST_NAME ARGS_COMBINED_SIZE REQUEST_BODY.
   The edge server may also support XML encoded POST bodies, such as from an AJAX or SOAP call. The request will have Content-Type: text/xml and valid XML body, in which case the process extracts the body with selectors: XML REQUEST_BODY. An alternative option uses regex matching.
   Cardholder data from the POST body may include card number, person name, expiration date, CVI/CVV code, etc. The data from the POST body must arrive encoded appropriately for the third party tokenization agent.
   URL decode the value from the POST body if necessary for a non-HTTP API.
3. Create a new POST body and send it in a forward request to the payment gateway.
   The POST includes the card number and required cardholder data for the payment gateway interface sent in an HTTPS POST request.
   If the POST fails a retry-post is attempted, but only after validation with payment gateway (this should not cause a duplicate token to be created).
   The POST to the payment gateway may require merchant authenticators like username, password, or an HMAC key. These values need to be referenced by key management name in the metadata.
   The edge server process is able to access a secret key to create an HMAC authenticator for a set of data fields in the POST body, and to add that authenticator to the POST body.
4. Receive and parse the response from the payment gateway
   Response body may be parsed via regex or fixed string matching.
   On OK response: replace card number with the token in the POST body.
   Once replaced, remove the card number from process memory.
   On error response or timeout: take appropriate fail-action—see below. Sending the gateway's failure indication is an acceptable default behavior as the merchant needs to deal with gateway failure cases already.
   The payment gateway should be fast so calls are not delayed for long. The edge process may apply a timeout to gateway requests to prevent resource exhaustion.
5. Log the result of the transaction.
   This may include a numeric response code, reason or decision string, transaction identifier, and other non-PII data.
6. Continue the forward request to the merchant's site with the modified POST body. The POST will carry different cardholder data.
   The merchant must modify their application to handle the incoming token.

### 1.3 Payment Gateway Integration

The interface to tokenization may be through profile functionality. A profile typically represents an end user, referring to their PII (name, address, phone, card number, expiration, etc.) with an anonymous token or profile identifier. Profile functionality may be accessed via a SOAP request, by a web service using binary API, or through an HTTPS POST interface with name=value attributes in the request and response.

In the case of new users visiting a customer web site, the edge server process will request a new token be created. If the user has already visited the site they should have a profile already. In this case the POST from the merchant's form should contain only the profile identifier, not the full card number. In this case we would not call the tokenization API, just pass the POST through immediately.

If the call through the edge server process does create a profile for the user, the merchant should extract the profile from the request and store it in their database for use next time the user returns.

### IPA Implementation

When IPA is used, an IPA request is converted to a POST by specifying the “post-body” tag explained above, which also adds a “Content-Length” header. The “post-body” can contain arguments that are expanded. These arguments must be appropriately encoded, either as url-encoded, plain text, or html-entity-encoded, depending on the type of POST body (xml, name-value pairs). A “Content-Type” header is added using a <edgeservices:modify-outgoing-request.add-header> tag in the <match:processing-agent-request> tag, specifying “application/x-www-form-urlencoded” or another appropriate value.

To allow a POST in an IPA, <security:allow-post>on</security:allow-post> is needed in the <match:processing-agent-request> tag.

### Upstream POST Rewriting

The upstream POST preferably is modified with the variables extracted from the IPA response. The tags <edgeservices:add/remove/modify-outgoing-request.remove-post-argument> allow modification of the POST body. To extract values from the incoming POST request, an <edgeservices:inspect-request-body.status> tag is activated and an appropriate <edgeservices:inspect-request-body.limit> is specified. A <match:regex> tag allows the process to extract values from the POST body. For the incoming POST request, a selector such as “ARGS_POST:fieldname” may be used, with regex=“.*” provides the field value in the desired format. To extract values from the IPA response, a regex selector called IPA_RESPONSE_BODY may be used. This selector specifically allows the access of the IPA response body. The IPA POST http status response is extracted using a selector “IPA_RESPONSE_STATUS”.

### Variants

Interaction with Fraud Detection

As noted above, the HTTP POST message processing described above may be leveraged to create an edge-based fraud module to do device detection or identification prior to routing the request to the merchant website. This reduces integration demands on a merchant site by obviating a separate call out to the fraud platform (from the merchant site).

The CDN customer (the merchant) would still have to integrate a device id or risk score into its order management system or process. One option is to modify the software to accept or reject transactions on the basis of real-time risk scoring. Another is to provide the vendor an offline risk score that the merchant can review during their order fulfillment process, declining to fill fraudulent transactions.

The edge services fraud interaction leverages POST scanning, IPA-based forward request to a fraud platform, and risk score injection into the original POST. There is no need to remove or replace an existing field, and perhaps no need to modify the POST—the risk score could be inserted as an HTTP header using existing capabilities.

The edge-based fraud detection may be carried out at the same time the tokenization occurs (i.e., within the same HTTP request processing). In such case, two (2) separate intermediate requests are carried out, one to the fraud engine (for the risk score) and one to the payment gateway (for the token).

### Payment Gateway and Vault

This module relies on a third party payment gateway with secure data vault that associates tokens with the relevant cardholder data (card number, name, address, phone . . . ) and provides a secure interface to extract PII data given a token.

### Other Payment Gateway Functions

As previously described, the edge server process can invoke other payment processing API functions, for example request credit approval, in parallel with the tokenization request. Approval status added to the POST body saves the merchant having to initiate the request separately.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. While given components of the system have been described separately, one of ordinary skill will appreciate that some of the functions may be combined or shared in given instructions, program sequences, code portions, and the like.

As noted above, the described techniques may be implemented with respect to any HTTP request having a message body (including, without limitation, GET, PUT, other WebDAV types, and the like).

In general, the information returned to the edge server (from the IPA processing) is a function of the data extracted from the HTTP message. As described, a third party can associate (map) the extracted data with the information returned as needed dependent on the particular application.

Having described our invention, what we now claim is as follows.

1. Apparatus, comprising:
a processor;
computer memory holding computer program instructions that when executed by the processor perform a method under the control of a configuration file, the method comprising:
receiving an HTTP message body;
parsing the HTTP message body to extract data;
issuing an intermediate request to an external process, passing the data extracted from the HTTP message body;
receiving a response from the external process;
inserting the response into the HTTP message body to create a modified HTTP message body; and
forwarding the modified HTTP message body to a target application for further processing.

2. The apparatus as described in claim 1 wherein the HTTP message body is an HTTP POST.

3. The apparatus as described in claim 1 wherein the data extracted is a credit card number and the external process is a payment gateway tokenization process.

4. The apparatus as described in claim 1 wherein the external process is a fraud engine and the response inserted into the HTTP message body is a risk score.

5. The apparatus as described in claim 1 wherein the external process includes an associated database and the response inserted into the HTTP message body is a value derived from a lookup into the database.

6. The apparatus as described in claim 1 wherein the configuration file is configured as XML.

7. The apparatus as described in claim 1 wherein the intermediate request is issued to the external process over a secure link.

8. The apparatus as described in claim 1 wherein the response inserted into the HTTP message body obfuscates the data extracted.

9. The apparatus as described in claim 1 wherein the response inserted into the HTTP message body enhanced the data extracted.

10. A method operative in an edge server of a distributed network, the distributed network having infrastructure shared among participating third party customers, the method comprising:
receiving an HTTP POST message body;
parsing the HTTP POST message body to extract data;
issuing an intermediate request to an external process, passing the data extracted from the HTTP POST message body;
receiving a response from the external process;
inserting the response into the HTTP POST message body to create a modified HTTP POST message body; and
forwarding the modified HTTP POST message body to a target application for further processing.

11. The method as described in claim 10 wherein the response inserted into the HTTP POST message body protects the data extracted.

12. The method as described in claim 10 wherein the response inserted into the HTTP POST message body enhances the data extracted.

13. The method as described in claim 10 wherein the external process is a tokenization process associated with a third party entity.

14. The method as described in claim 10 wherein the external process is a fraud detection process associated with a third party entity.

15. The method as described in claim 10 wherein the external process is an Internet-accessible web application associated with a third party entity.
